(19) United States
(12) Patent Application Publication
(10) Pub. No.: US 2002/0178128 A1
(43) Pub. Date: Nov. 28, 2002

(54) System and method for providing payment-authorized printing services via the internet and via a stand alone device

(76) Inventors: Steven Chen, Mountain View, CA (US); Bahar Daijavad, Menlo Park, CA (US); Gary George, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/862,707

(22) Filed: May 23, 2001

(51) Int. Cl. G06F 17/00

(52) U.S. Cl. 705/400

(57) ABSTRACT

A method and device for printing a document. The method comprises the steps of: receiving electronic data which represents a document to be printed; converting the received electronic data into a format suitable for printing; authorizing user payment information; and printing a document on predetermined paper sheets upon receipt of a signal from the payment authorization unit. The device comprises a housing unit having an output bin which provides user access to the printed documents and an input bin for inputting predetermined types of paper to the printer unit. The device also comprises a transmitter and receiver for coupling the device to a network, and a touch screen for interfacing the user with the device in order to customize predetermined features of the document. The device further comprises a media device for inputting electronic document information from predetermined portable media device and a payment authorization device. The device further comprises a color printing unit for receiving the electronic document information from either the network transmitter or the input media device and based on the customized features of the document as set forth by the user and a signal from the credit card authorization device, converting the electronic document information into a paper copy.

### TECHNICAL FIELD

The present invention relates to a vending system for the distribution of a service. More specifically, the invention relates to vending or dispensing machines that perform printing services.

### BACKGROUND OF THE INVENTION

Conventionally, printing is performed by either a direct or network connection between a computer workstation and a printer or at a commercial printing facility. If a direct or network connection is not available to a user, then a user can save the file on a disk and wait to find a printer where one is available. However, this is inconvenient, because public printers are not widely available. Also, public printers may not be readily available.

A user could go to a commercial copy center such as KINKO's ™, to print a document. The commercial copy centers, however, tend to be crowded, expensive (up to 1.50 cents per page depending on type of printing) and require a great deal of time. Also, if the user is in a location where there is no access to such facilities, such as an airport, bus station or library, then the user has no options.

Also, some computer manufactures sell hand-held or portable printer systems, but they tend to be expensive and not compatible with all computer systems.

### BRIEF SUMMARY OF THE INVENTION

In one respect, the invention is a device for printing a document. The device comprises a receiver unit for receiving electronic data, which represents a document to be printed, and converting the received electronic data into a format suitable for printing. The device also comprises a payment authorization unit, and a printer unit for receiving the converted electronic data and printing the document on predetermined paper sheets upon receipt of a signal from the payment authorization unit.

In another respect, the invention is a device for the production and sale of documents. The device comprises a housing unit having an output bin, which provides user access to the printed documents, and an input bin for inputting predetermined types of paper to the printer unit.

The device also comprises a transmitter and receiver for coupling the device to a network, and a touch screen for interfacing the user with the device in order to customize predetermined features of the document. The device further comprises a media device for inputting electronic document information from predetermined portable media device and a payment authorization device. The device further comprises a color printing unit for receiving the electronic document information from either the network transmitter or the input media device, and based on the customized features of the document as set forth by the user, a signal from the credit card authorization device, converting the electronic document information into a paper copy.

In yet another respect, the invention is a method for printing a document. The method comprises the steps of: receiving electronic data which represents a document to be printed; converting the received electronic data into a format suitable for printing; authorizing user payment information; and printing a document on predetermined paper sheets upon receipt of a signal from the payment authorization unit.

In still yet another respect, the invention is a method for printing a document. The method comprises the steps of retrieving electronic data representing a document to be printed via a portable media input device; authorizing user payment information; and printing a hard copy of the retrieved electronic data based on the payment authorization.

Certain embodiments of the invention are capable of achieving certain advantages, including some or all of the following: (1) allow users access to printing services in places that do have access to commercial copy services or local printers; (2) provide commercial copy services, such as color printing, collating and stapling without having to rent large amounts of commercial space; (3) allow users to print documents stored locally via a disk, from a user's e-mail server, virtual memory storage area on the Internet, from a PDA (Personal Digital Assistant) or via a cellular phone. Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

The invention is described in greater detail hereinafter, by way of example only, through description of a preferred embodiment thereof and with reference to the accompanying drawings in which:

FIG. 1 illustrates the front view of a printing services vending machine, according to an embodiment of the invention;

FIG. 2 illustrates a side view (Cut-out view) of the printing services vending machine, according to an embodiment of the invention;

FIG. 3 illustrates the interaction of the virtual storage unit, the Internet and the printing services vending machine, in accordance with an embodiment of the invention;

FIG. 4 illustrates a block diagram of the printing system of the printing service vending machine, in accordance with an embodiment of the invention; and

FIG. 5 illustrates a flow chart of the printing services vending machine operation, according to an embodiment of the invention.

### DETAILED DESCRIPTION OF DISCLOSURE

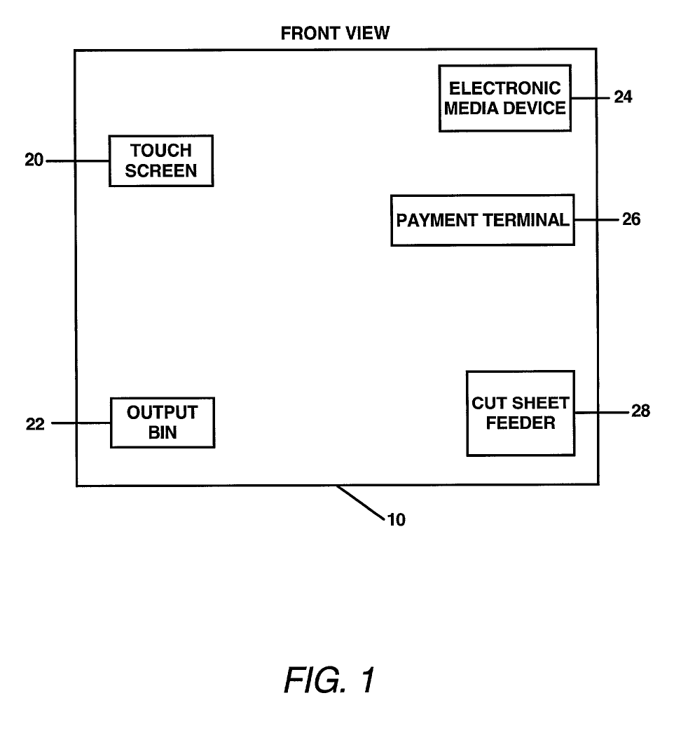

FIG. 1 illustrates the front view of a printing services vending machine 10 according to an embodiment of the invention. The front view of the printing services vending machine 10 incorporates a housing unit comprising, an LCD touch screen 20, an output bin 22, slots for magnetic media 24 (for example, floppy disks or zip disks), a payment terminal 26, and a bin for a cut sheet feeder 28. The LCD touch screen 20 allows a user to interface with the vending machine. The LCD touch screen 20 can provide input and/or preview information pertaining to the document. Also, the screen 20 is configured to operate in conjunction with the payment terminal 26 in order to input payment information.

The output bin 22 is the collection area for the printed documents. The output bin 22 is accessible to the user. The vending machine 10 includes an electronic media device 24 where portable media can be input into the vending machine 10. The payment terminal 26 can be configured to accept cash and/or credit/debit cards. The bin for a cut sheet feeder 28 allows the user to input paper into the printer manually.

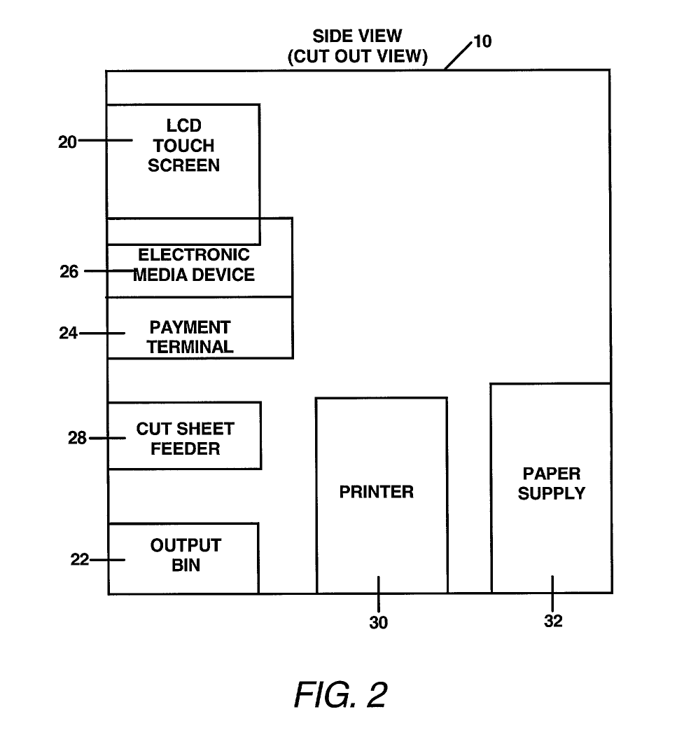

FIG. 2 illustrates the printing services vending machine housing unit 10 from the side. The LCD touch screen 20, the output bin 22, the electronic media device 24, payment terminal 26 and cut sheet feeder 28 are shown. Also shown are a printer 30 and a paper supply 32. The printer 30 is well known in the art and the preferred embodiment of the invention would employ a color laser jet printer. The paper supply 32 is automatically fed into the printer upon demand. The paper supply 32 could consist of any of the known types and size of paper, which are well known in the art.

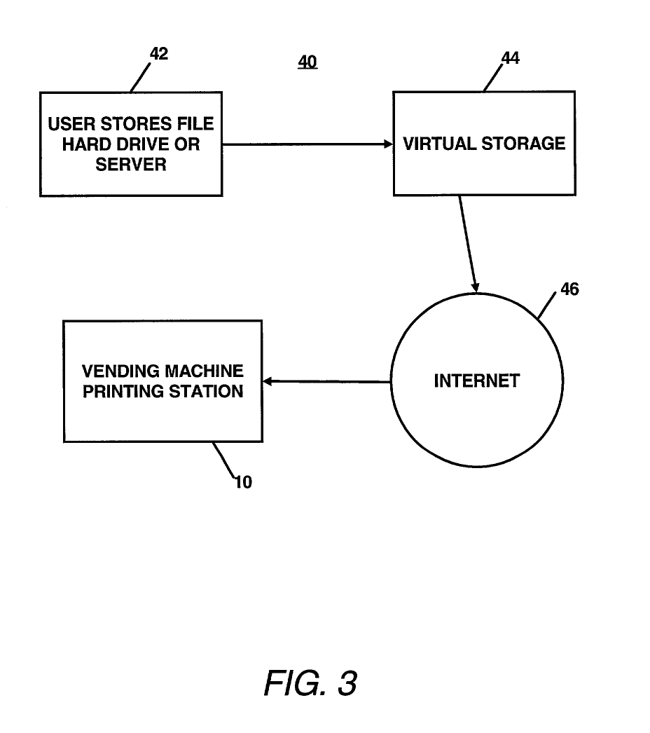

FIG. 3 illustrates a block diagram of an architecture 40 of the vending machine 10 accessing electronic document information via the Internet. The elements of the architecture include a user's file 42, a virtual storage unit 44, the Internet 46, and the vending machine 10.

The user creates a document using a conventional word processor, spreadsheet, database or any other software package. The user then stores the electronic document information on a local hard drive or a server 42. The user specifies that an electronic representation of the document is stored on a virtual storage device 44, such as I-drive™ or any other known virtual storage devices accessible on the Internet 46.

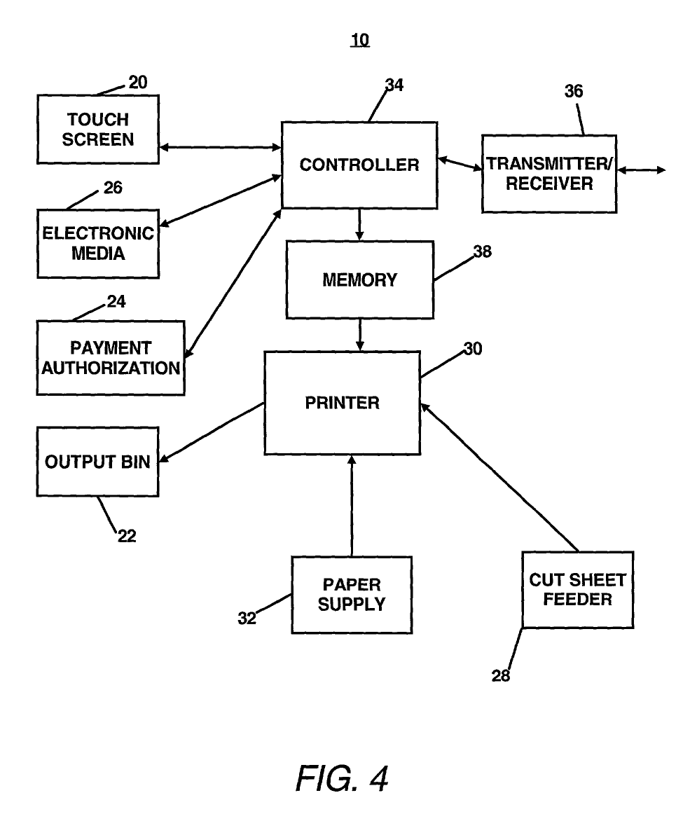

When the user accesses the printer vending 10, the user can use the LCD touch screen 20 to access the electronic document information stored in the virtual storage device 44 via the Internet 46. The user uses the LCD touch screen 20 to specify the electronic document information stored on a virtual storage device 44. The printer vending station 10 downloads the electronic document information stored in the virtual storage device 44 from the Internet 46 and into the printer vending machine 10. The transmitter/receiver unit 36, as shown in FIG. 4, controls the download. The transmitter/receiver unit 36 receives the electronic document information by conventional methods and converts the downloaded electronic information into a format suitable for printing. The transmitter/receiver unit 36 then sends the download electronic document information to a memory device 38 for storage. Once the payment authorization terminal 24 has authorized payment, the printer 30 prints the stored electronic document information. The printed sheets are output to the output bin 22.

FIG. 4 illustrates a block diagram of the preferred embodiment the printing service vending machine 10. The elements of the vending machine 10 are the LCD touch screen 20, output bin 22, payment authorization terminal 24, electronic media device 26, cut sheet feeder 28, printer 30, paper supply 32, controller 34, transmitter and receiver unit 36, and memory device 38.

The LCD touch screen 20 can be of the type well known in the art (such as disclosed in U.S. Pat. No. 5,105,186). The touch screen uses a graphical user interface (GUI) (not shown) of the type known in the art. The GUI allows the user to interface with the machine by enter commands. The LCD touch screen 20 is coupled to the controller 34 and interacts with all other elements of the system. The user can use the LCD touch screen 20 to customize the printing process by selecting various features (such as paper size, color, font style and size, staple, collate the document, front and back page printing etc.). Alternatively, you could have a standard display and any input device.

The electronic media device 24 has a plurality of input ports to be adapted for use with plurality of portable electronic media (e.g., floppy disks, ZIP disks). Also, the device 24 can be adapted to for use with PDAs (Personal Digital Assistants) such as Palm, Jornada, Blackberry, and/or various telecommunications devices, in addition to, wireless Internet connections using well-known data squirting techniques. The electronic media device 24 can be of a type known in the art. The electronic media device 24 is coupled to the controller 34. The user, via the LCD touch screen 20, can access the document stored in the electronic media device 24.

The payment authorization terminal 26 can be of a type known in the art. The payment authorization terminal 26 is coupled to the controller 34. The payment authorization terminal 26 has a port where the user inputs a credit card (although the system could be adapted to accept cash). The credit card information would be transmitted (in a known manner) via the transmitter/receiver unit 36 to a server (not shown) that would authorize the purchase. Once the payment has been authorized, the electronic document information is transferred from the portable electronic media to a memory device 38 by a command from the controller 34.

The controller 34 is a microprocessor that controls the operations and processes for the vending machine 10 . For example, when the payment has been authorized, the controller 34 transmits a signal to the printer 30, enabling the printer 30 to print any stored electronic documents according to any customized features provided by the user. The controller 34 is adapted to transmit electronic document information from the transmitter/receiver unit 36. The controller 34 is coupled to the transmitter/receiver unit 36, LCD touch screen 20, electronic media device 24, memory device 38 and printer 30. The controller 34 is of a kind well known in the art.

The memory device 38 is of a kind well known in the art. The memory device 38 receives the retrieved electronic document information from either the transmitter/receiver unit 36 or the electronic media device 24 and stores that document information until the controller 34 indicates that the document information should be transferred to the printer 30.

The printer 30 can be color laser jet printer or any other known type of printer. The functions of a printer are well known in the art, and the printer 30 uses conventional printing techniques. The printer 30 receives the electronic document information from either the electronic media device 24 or the transmitter/receiver unit 36 in a form suitable for printing. The printer 30 also receives a signal from the controller 34 indicating that the printing can commence. The printer 30 then adjusts for any customizations requested by the user and prints the document using paper from either the paper supply 32 or the cut sheet feeder 28. The paper supply is stored in the paper tray in the printer 30. Any paper input through the cut sheet feeder 28 is inserted to the printer 30 via a manual feed tray.

Each printed page of the document is output into the output bin 22. A window (not shown) can be lifted allowing the user to obtain the printed pages in the output bin 22.

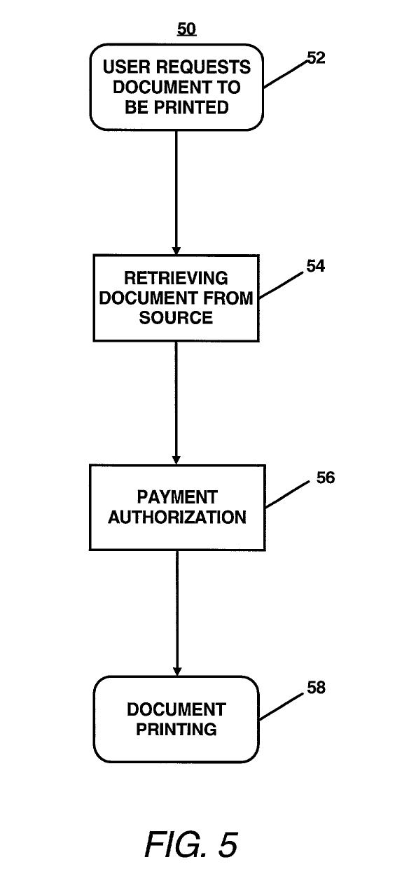

FIG. 5 illustrates a flow chart 50 showing a method of operating the printing services vending machine 10, in accordance with the preferred embodiment of the invention. The method 50 begins when the vending machine 10 is requested to print a document (step 52). Once the request has been verified, the vending machine 10 retrieves the electronic data representing the document via either a network, such as the Internet (as discussed above with regards to FIG. 3), or from a portable media device stored in the electronic media device 26. In the case of a portable media device, a user indicates via the LCD touch screen 20 that the electronic document information will be input via the electronic media device 24 (step 54). Once user has input a magnetic disk, the LCD touch screen 20 is used to determine the particular electronic document that is to be printed. The user employs the LCD touch screen 20 to make selections of the various types of printing features available (e.g. number of copies). The specified electronic information is read from the electronic media device 24 into storage device 38.

Once the electronic data has been retrieved, the vending machine 10 authorizes payment information for the requested printing services (step 56). The LCD touch screen 20 communicates the payment information with the controller 34 and the payment authorization terminal 26. The user is then requested to provide payment information via either a credit card or cash. Once the payment has been authorized in a conventional manner, the user selects to print the document.

The printing operation is performed on the electronic document information using either paper from the paper supply 32 or paper manually input via the cut sheet feeder 28. The printed sheets are output to the output bin 22. The processing steps just described can be performed in a different order (or even simultaneously), as those skilled in the art should appreciate.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one of ordinary skilled in the art to utilize the invention in various embodiments and with various modifications as are suited to the particular use contemplated. It is intended that the scope of the invention be defined by the claims appended hereto and their equivalents.

We claim:

1. A device for printing a document, the device comprising:
a receiver unit configured to receive electronic data that represents a document to be printed;
a payment authorization unit; and
a printer coupled to the receiver and the payment authorization unit, wherein the printer prints the document upon indication from the payment authorization unit.

2. The device, according to claim 1, further comprising:
a first document input element for receiving the electronic data that represents a document to be printed from a network.

3. The device, according to claim 2, wherein the network is the Internet.

4. The device, according to claim 1, further comprising:
a display and input device configured to provide information regarding the document and payment information.

5. The device, according to claim 4, wherein the display and input device is a LCD touch screen.

6. The device, according to claim 1, further comprising:
an output bin that contains the printed document printed by said printer.

7. The device, according to claim 1, further comprising:
a second document input element for receiving the electronic data that represents a document to be printed from a portable media device.

8. The device, according to claim 1, further comprising:
an input bin that allows the user to input predetermined types of paper to the printer.

9. The device of claim 8, wherein the input bin is a cut sheet feeder.

10. A device for printing a document, the device comprising:
a receiver means configured to receive electronic data that represents a document to be printed;
a payment authorization means;
a memory means for storing the received electronic data that represents a document to be printed; and
a printing means, coupled to the receiver means, payment authorization means, and memory means for printing the document upon indication from the payment authorization means.

11. The device, according to claim 10, further comprising:
a first document input means for receiving the electronic data that represents a document to be printed from a network.

12. The device, according to claim 10, further comprising:
a second document input means for receiving said electronic data that represents a document to be printed from a portable media device.

13. The device, according to claim 10, further comprising:
a display means and input device means for providing information regarding the document and payment information.

14. A method for printing a document, the method comprising the steps of:
retrieving electronic data representing a document to be printed;
authorizing user payment information; and
printing a copy of the retrieved electronic data based on the authorizing.

15. The method according to claim 14, wherein the said step of retrieving further comprises the step of:
retrieving the electronic data representing the document to be printed from a network.

16. The method according to claim 14, wherein the said step of retrieving further comprises the step of:
retrieving the electronic data representing the document to be printed from a portable media device.

17. The method according to claim 14, further comprising the step of:
receiving user information regarding the document and the payment information.

18. The method according to claim 14, wherein the step of printing further comprises the step of:
accepting paper sheets from a first bin.

19. The method according to claim 14, wherein said step of printing further comprises the step of:
outputting the printed document into a second bin.

20. The method according to claim 15, wherein the network is the Internet.
